(19) United States
(12) Patent Application Publication
(10) Pub. No.: US 2025/0237494 A1
(43) Pub. Date: Jul. 24, 2025

(54) METHOD FOR MEASURING A PROPERTY OF A BAR

(71) Applicant: Progress Maschinen & Automation AG, Brixen (IT)

(72) Inventor: Alexander STUFLESSER, Lajen (IT)

(21) Appl. No.: 19/006,858

(22) Filed: Dec. 31, 2024

(30) Foreign Application Priority Data
Jan. 18, 2024 (EP) 24152586.4

(51) Int. Cl. G01B 11/16

(52) U.S. Cl. CPC G01B 11/16

(57) ABSTRACT

A method measures at least one property, in particular the straightness, of a bar, in particular a reinforcing bar, straightened by a straightening machine, in particular a rotor straightening machine. The at least one property of the straightened bar is measured after the outlet of the straightening machine by a contactless scanning device. The cut bar is deposited in a storage device, and the measurement of the at least one property of the bar is carried out by the contactless scanning device while the bar is deposited in the storage device.

### BACKGROUND OF THE INVENTION

The invention relates to a method for measuring at least one property, in particular the straightness of at least one bar, in particular reinforcing bar, straightened by a straightening machine, in particular a rotor straightening machine. The at least one property of the at least one straightened bar is measured after the outlet of the straightening machine by at least one contactless scanning device. Furthermore, the invention relates to a device for measuring at least one property, in particular the straightness, of at least one bar, in particular reinforcing bar, straightened by a straightening machine, and the device comprises at least one contactless scanning device.

Straightening machines for the production and provision of bars, individual bars or wires for reinforcement are known in many different types. Ideally, by straightening, absolutely straight reinforcing bars should be produced. In practice, however, it often happens that the straightened wires/bars are slightly bent. This can have a variety of causes, as the result depends on several factors, such as the starting material, the feed speed, the rotor speed or the alignment of the straightening wheels/straightening nozzles.

Methods have therefore already been developed that are aimed at achieving an improved straightening result. As a rule, the straightened workpiece is guided past a stationary measuring device directly after passing through the straightening unit before it is subsequently cut off. The measured values are used to adjust the parameters, such as feed speed, rotor speed or alignment of the straightening wheels/straightening nozzles, if tolerance values are exceeded, in order to achieve an improved straightening result for the next wire or the next batch of wires/bars.

One disadvantage of this prior art is that, although the straightening results can certainly be improved with the well-known methods, there is no final inspection of the straightened and cut bars/wires. Wires that are bent in the production line after the measuring process, for example during the cutting process or in the outlet of the straightening machine, cannot be sorted out using the methods known to date.

Contactless scanning devices are also known and are usually arranged directly after the straightening unit in straightening machines, wherein the bar to be measured is moved past the scanning device by the feed. With the known devices, the straightness of the straightened bar is therefore still measured in the production line, which has the disadvantage that deformations that occur during the passage of the production line after passing the scanning device can no longer be measured.

### SUMMARY OF THE INVENTION

Based on this prior art, the object of the invention is to provide an improved method and an improved device while avoiding the aforementioned disadvantages. In particular, an improved measurement of the property of the straightened bar at the end of the production line, in particular at the outlet, and a quality inspection of the straightened bars/wires at the end of the production line are to be achieved.

In the method according to the invention, this is achieved by depositing the cut bar in a storage device and measuring the at least one property of the bar by means of the at least one contactless scanning device while the bar is deposited in the storage device.

In the previously known methods, the measurement of the property of the workpiece to be straightened, in particular the straightness, was carried out between the straightening unit and the cutting device. However, in the method according to the invention, the measurement is moved to the end of the production line. This means that bending of the workpiece that occurs in the production line after straightening, for example during the cutting process, can also be measured, whereby the measuring process simultaneously determines the rejects and thus achieves quality control.

According to a preferred embodiment of the invention, in order to measure the property of the bar, the position of the bar remains unchanged and the scanning device is moved relative to the bar. It has been found that it is particularly advantageous, for achieving a solution which is easy to implement in practice, if the scanning device is moved relative to the bar radially and/or parallel to a longitudinal direction of the bar.

In other words, the bar is straightened and cut to length by the straightening machine before it is deposited in the outlet and measured by a pivotable scanning device.

According to an alternative embodiment of the invention, for measuring the property of the bar, the position of the scanning device remains unchanged and the bar is preferably moved radially relative to the scanning device.

In this embodiment, the scanning device is therefore arranged stationary at the end of the production line and the reinforcing bar to be measured is moved relative to the scanning device. A space-saving embodiment can be achieved if the reinforcing bar to be measured is rotated around its own axis and is measured by means of the contactless scanning device.

Particularly accurate measurement results can be achieved if the property is measured by means of at least one sensor, preferably a distance-based laser sensor. A measuring method that is uncomplicated to carry out and in which the means used to carry out the method can also be designed to be simple results when the scanning device comprises multiple sensors, and a position profile of the bar to be measured is created from the measured values of the individual sensors and a reference value is derived and the reference values of the individual position profiles determined in this way are set in relation to each other.

In other words, the sensors, which are arranged on a rotatable shaft, are pivoted around the bar stored in the storage device, and the sensor records the measured values during the pivot cycle, resulting in a position profile of the bar in relation to the pivot angle. A specific reference value is then derived for each position profile. In fact, the reference values of the individual position profiles represent the measurement result with regard to the property of the bar to be measured.

A particularly simple method for measuring the straightness of the bar is achieved if a distance profile of the bar to be measured is created as the position profile in relation to the pivot angle of the sensor and the minimum value of the resulting curve is derived as the reference value.

The reference values determined can be used in two ways.

Firstly, an upper and a lower tolerance limit for the reference values can be defined for the determination of rejects in order to sort out bars for which the determined reference values exceed these tolerance limits.

Secondly, the determined reference values can be used to achieve a better straightening result for subsequent batches of bars to be straightened by adjusting the setting parameters for the straightening machine if, according to a further embodiment of the invention, the reference values are transmitted to a control device for the straightening machine and the straightening elements of the straightening machine are adjusted as a function of the determined reference values.

With regard to the device, the problem is solved by providing that the device has a storage device for the straightened and cut bar and that the at least one contactless scanning device is arranged movably relative to the storage device, preferably on the storage device. A solution that is particularly easy to operate and robust in practice is achieved if, according to a preferred embodiment of the invention, the scanning device is arranged on the storage device so as to be radially movable, preferably pivotable.

In contrast to the prior art, the device for measuring the property of the straightened bar is therefore arranged at the end of the production line for the bar in the so-called reject area of the straightening machine in such a way that it is freely accessible without having to stop any working machine parts of the straightening machine or remove machine elements, thus achieving a particularly maintenance-friendly solution that does not affect the production process of the straightening machine.

If the scanning device has multiple sensors, preferably distance-based laser sensors, which are arranged on a rotatably mounted shaft, this results in optimal data indicative of the property, in particular the deformation of the bar. It has proven to be favorable for a reliable measurement if the scanning device extends over the entire length of the bar to be measured.

A particularly cost-effective and at the same time robust embodiment of the invention provides that the storage device has a support surface and a contact surface for the bar to be measured, the support surface and the contact surface enclosing an angle of less than 120°, preferably of 85°, and the contact surface having a plurality of, preferably slot-shaped, through-openings. A particularly simple and reliable measurement of the property of the bar is achieved if the scanning device is mounted on the side of the contact surface facing away from the bar to be measured, wherein the sensors of the scanning device are arranged in the area of the through-openings, preferably congruently.

In other words, the sensors can measure the distance of the bar from the contact surface through cut-outs formed by the slot-shaped through-openings, wherein the measuring accuracy or the conclusion as to the straightness of the bars is particularly high or accurate if a sensor is arranged in the area of each through-opening.

If, as in a further embodiment of the invention, the support surface is arranged to be pivotable relative to the contact surface, the now straightened, cut and measured bar can be transported further downwards out of the storage device in a simple manner by pivoting the support surfaces.

### BRIEF DESCRIPTION OF THE DRAWINGS

Further details and advantages of the invention are explained in more detail below with reference to the drawings, in which:

FIG. 1 shows a straightening machine;

FIGS. 2a, 2b show different embodiments of a scanning device according to the invention;

FIGS. 3a, 3b show a front view and a perspective view of the outlet;

FIG. 4a shows an enlarged section of FIG. 3a;

FIG. 4b shows the recorded profile of a measured bar;

FIGS. 5a, 5b show a cross-section of the position of differently bent bars in the scanning device;

FIG. 6a shows a schematic sketch of a bent bar in the scanning device; and

FIG. 6b shows the recorded profile of a bent bar.

### DETAILED DESCRIPTION OF THE INVENTION

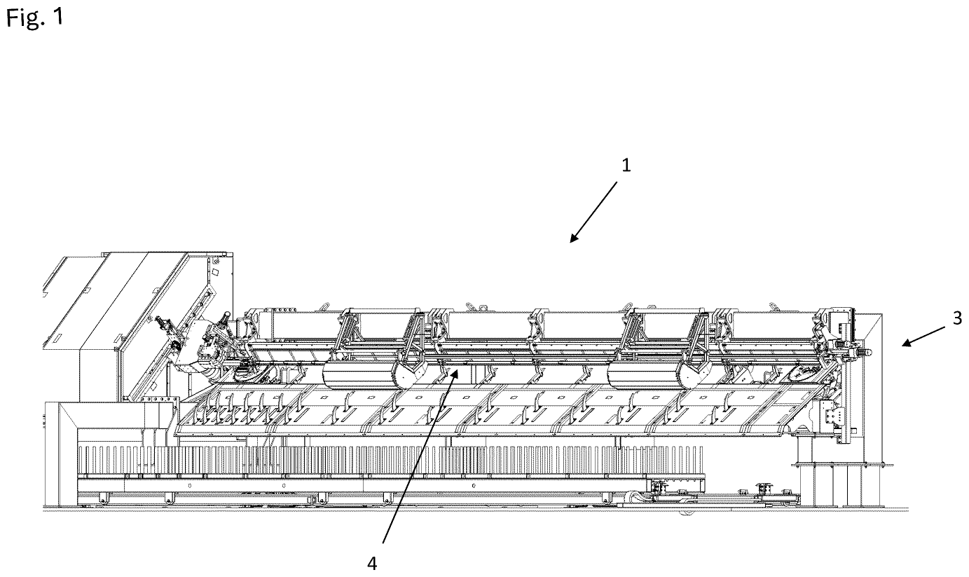

In the straightening machine 1 shown in FIG. 1, the scanning device 4 is arranged in the so-called outlet 3 of the straightening machine 1. In contrast to the methods known from the prior art, in the method according to the invention the bar 2 is therefore measured after cutting, which has the advantage that the bar 2 is measured over its entire length, which is not the case in the methods known from the prior art due to the arrangement of the scanning device directly after the straightening unit and before cutting.

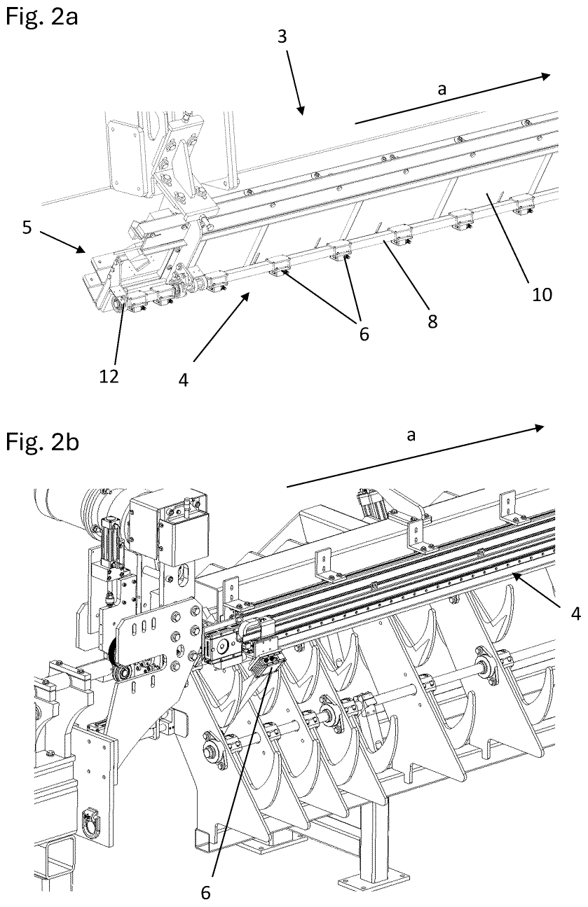

In the preferred embodiment of the invention shown in FIG. 2a, the scanning device 4 has a shaft 8 which can be pivoted via a motor 12 and on which a plurality of sensors 6 are arranged. The shaft 8 is arranged on the rear side of the contact surface 10 in such a way that the sensors 6 are congruent with the through-openings 11 in the contact surface 10, the through-openings 11 extending over the entire length of the contact surface 10 in the longitudinal direction a of the bar 2 to be measured. The bar 2 is thus measured in a simple manner by pivoting the shaft 8 and thus the sensors 6, wherein the sensors 6 can measure the distance of the bar 2 located in the storage device 5 during the pivoting cycle through the through-openings 11 in the contact surface 10.

An alternative embodiment is shown in FIG. 2b. In this embodiment of the invention, the sensor 6 is moved linearly to the longitudinal direction a of the bar 2 to be measured. This arrangement is particularly suitable if an image-based height comparison sensor is used for the measurement. However, it would also be conceivable to move a laser-based distance sensor 6 linearly in the longitudinal direction a of the bar 2 and to perform a distance measurement at predetermined intervals by pivoting.

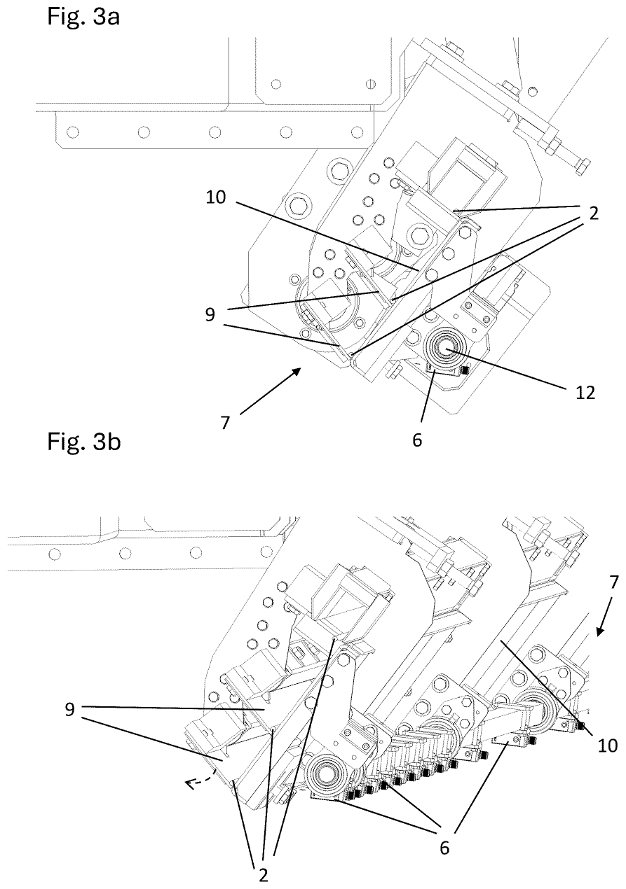

The following FIGS. 3a to 6b all relate to the preferred embodiment shown in FIG. 2a. FIGS. 3a and 3b show a view and a perspective of the device 7 according to the invention for measuring the property of a bar 2.

In the embodiment shown, the device 7 arranged in the outlet of the straightening machine 1 has a contact surface 10 and multiple support surfaces 9. The contact surfaces 9 are designed as pivoting flaps. The straightening machine 1 produces the bars 2 in the production line. After cutting, the bar 2 remains in the production line. In the embodiment shown, this is the uppermost pivoting support surface 9. By pivoting the support surface 9 downwards (in the direction of the arrow), the cut bars 2 are conveyed downwards in the device, wherein the pivoting support surfaces 9 also act as a buffer when the bar 2 is conveyed from top to bottom. At the lower end of the device 7, the sensors 6 arranged on a pivoting shaft 8 are located on the side of the contact surface 10 facing away from the support surface 9. The sensors 6 can measure the distance of the bar 2 located in the lowest storage device 5 through the through-openings 11 in the contact surface 10.

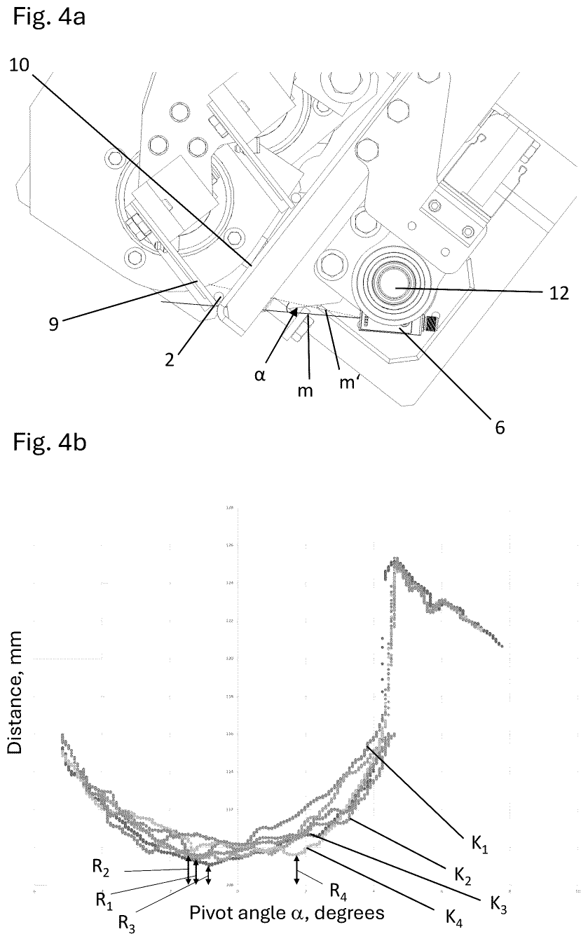

FIG. 4a illustrates the measuring principle. The bar 2 lies in the lowest storage device 5 between the support surface 9 and the contact surface 10. The sensor 6 is pivoted with the shaft 8 via the motor 12 and records the distance to the bar 2 during the pivot cycle. The pivot cycle starts in the zero position with the measuring beam m and ends after passing through the pivot angle α with the measuring beam m′. During the pivot cycle, the sensor 6 measures the distance to the bar 2 and thus records a distance profile in relation to the pivot angle α.

FIG. 4b shows a recorded distance profile of the bar 2. The curves K1 to K4 correspond to the measurement results of sensors 6 arranged one behind the other in the longitudinal direction of the bar 2. The pivot angle α is shown in degrees on the X-axis and the measured distance in mm on the Y-axis, with the measurement being taken from right to left.

The measuring beam m therefore strikes the contact surface 9 first, so that the distance first increases when the sensor 6 is pivoted until the measuring beam m strikes the bar 2. Due to the round surface of the bar 2, the distance initially becomes smaller and smaller until the measuring beam m passes the apex and the distance increases again until, after running through the pivot angle α, the measuring beam m breaks away from the surface of the bar 2 and hits the support surface 9 again (no longer visible in the diagram).

In the embodiment shown, a position profile in the form of a distance profile of the bar 2 to be measured in relation to the pivot angle α of the sensor 6 is therefore created by each sensor 6 and the minimum value of the resulting curves K1 to K4 is subsequently derived as the reference value R1 to R4.

The reference values R1 to R4 determined in this way are then set in relation to each other. If the determined reference values R1 to R4 are all within a tolerance limit, ideally even at the same point, the measurement result is a straight bar. If one or more of the determined reference values R1 to R4 exceeds this tolerance limit, the measurement result is an uneven or curved bar.

The method according to the invention can therefore be used to determine rejects in a simple manner and, at the same time, the invention can also be used to cover the needs of adjusting the straightening machine based on the reference values determined, which are already known in the state of the art.

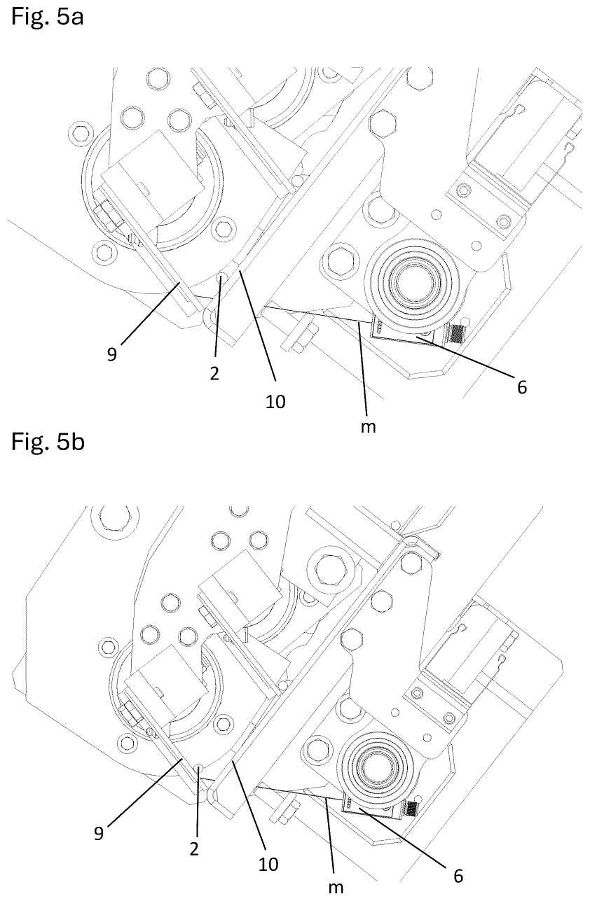

FIG. 5a shows the position of a bar 2 bent upwards in the storage device, while FIG. 5b shows the position of a bar 2 bent downwards in the storage device.

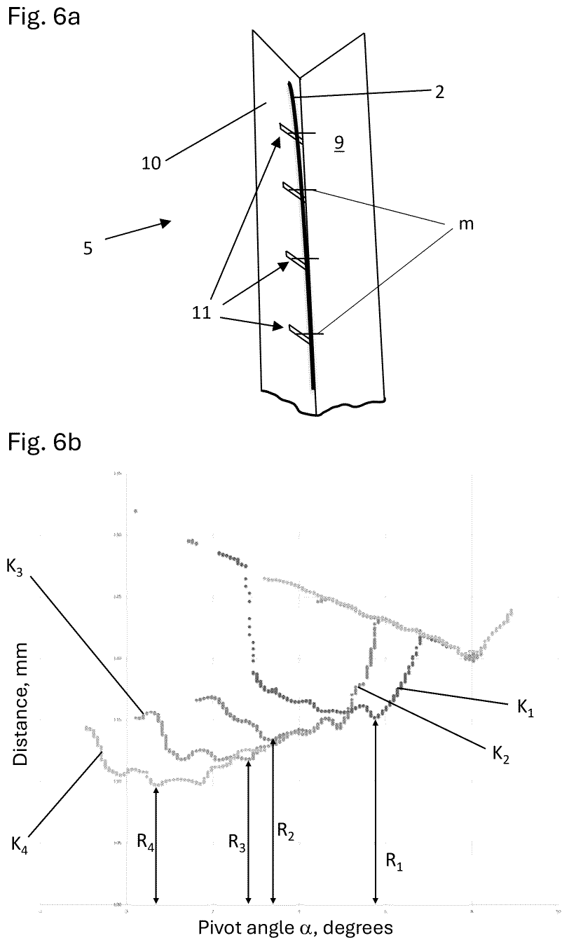

FIG. 6a shows a schematic top view of a bar 2 lying in the storage device 5 and bent upwards. The measurement is again carried out using a distance-based laser sensor (not shown). During the pivoting of the shaft 8, the measuring beams m of the sensors 6 pass through the through-openings 11 in the contact surface 10 and, during the pivoting cycle, first hit the support surface 9, then the bar 2 and then the support surface 9 again.

Analogous to FIG. 4b, FIG. 6b shows the resulting distance profiles of the measurements of a bent bar 2. Again, the measuring beam m first hits the support surface 9, the distance then becomes smaller when the measuring beam m hits the bar 2, wherein the curves K1 to K4, which were again measured by sensors 6 arranged one behind the other in the longitudinal direction of the bar 2, do not coincide in this measurement of a bent bar 2. The determined reference values R1 to R4 differ considerably and are outside the tolerance limit, so that the measurement result of the measurement profile shown in FIG. 6 shows a bent bar 2.

Although the invention has been described in concrete terms on the basis of the embodiment shown, it goes without saying that the subject matter of the application is not limited to this embodiment. Rather, measures and modifications which serve to replace the idea of the invention are quite conceivable and desirable. For example, the device according to the invention for carrying out the method could be used completely decoupled from a straightening machine and, for example, isolated from the production process for measuring the straightness of reinforcing bars.

1. A method for measuring at least one property, in particular the straightness, of at least one bar, in particular reinforcing bar, straightened by a straightening machine, in particular a rotor straightening machine, wherein the at least one property of the at least one straightened bar is measured after the outlet of the straightening machine by a contactless scanning device, wherein the cut bar is deposited in a storage device and the measurement of the at least one property of the bar is carried out by means of the at least one contactless scanning device while the bar is deposited in the storage device.

2. The method according to claim 1, wherein in order to measure the property of the bar, the position of the bar remains unchanged and the scanning device is moved relative to the bar.

3. The method according to claim 2, wherein the scanning device is moved radially and/or parallel to a longitudinal direction of the bar relative to the bar.

4. The method according to claim 1, wherein, for measuring the property of the bar, the position of the scanning device remains unchanged and the bar is preferably moved radially relative to the scanning device.

5. The method according to claim 1, wherein the property is measured by a sensor, preferably a distance-based laser sensor.

6. The method according to claim 1, wherein the scanning device comprises a plurality of sensors, wherein a position profile of the bar to be measured is created from the measured values of the individual sensors in each case and a reference value is derived and the reference values of the individual position profiles determined in this way are set in relation to one another.

7. The method according to claim 6, wherein a distance profile of the bar to be measured in relation to the pivot angle of the sensor is created as the position profile and the minimum value of the resulting curve is derived as the reference value.

8. The method according to claim 6, wherein the reference values of a control device for the straightening machine are transmitted and the straightening elements of the straightening machine are adjusted as a function of the reference values.

9. A device for measuring at least one property, in particular the straightness, of at least one bar, in particular reinforcing bar, straightened by a straightening machine, the device comprising at least one contactless scanning device, in particular for carrying out the method according to claim 1, wherein the device has a storage device for the straightened and cut bar and the at least one contactless scanning device is arranged movably relative to the storage device, preferably on the storage device.

10. The device according to claim 9, wherein the scanning device is arranged radially movably, preferably pivotably, on the storage device.

11. The device according to claim 9, wherein the scanning device has a plurality of sensors, preferably distance-based laser sensors, which are arranged on a rotatably mounted shaft.

12. The device according to claim 11, wherein the storage device has a support surface and a contact surface for the bar to be measured, the support surface and the contact surface enclosing an angle of less than 120°, preferably of 85°, and the contact surface having a plurality of, preferably slot-shaped, through-openings.

13. The device according to claim 11, wherein the scanning device is rotatably mounted on the side of the contact surface facing away from the bar to be measured, the sensors of the scanning device being arranged in the region of the through-openings, preferably congruently.

14. The device according to claim 13, wherein a sensor is arranged in the region of each through-opening.

15. The device according to claim 12, wherein the support surface is arranged so as to be pivotable relative to the contact surface.
